(19) United States
(12) Patent Application Publication
(10) Pub. No.: US 2024/0302151 A1
(43) Pub. Date: Sep. 12, 2024

(54) Card Thickness Guide

(71) Applicant: Jonathan B. Goldsmith, Hills, IA (US)

(72) Inventor: Jonathan B. Goldsmith, Hills, IA (US)

(21) Appl. No.: 18/182,167

(22) Filed: Mar. 10, 2023

(51) Int. Cl. G01B 3/04; G01B 21/08

(52) U.S. Cl. CPC G01B 3/04; G01B 21/08

(57) ABSTRACT

A process for measuring the thickness of a trading card. Being produced on transparent plastic and providing lines that are converted from points to millimeters the guide provides a process to measure a trading card from any side of the card, including while the card is inside a trading card holder. Preservation of edges, corners, and surface of a trading card being of utmost importance, the guide allows the user to obtain an accurate measurement of the card thickness to inform the decision of the size of the trading card holder that should be used.

### BACKGROUND OF THE INVENTION

### Field of the Invention

The present invention relates to trading cards and more specifically relates to the measurement of trading cards for placement in a plastic trading card holder.

### Description of the Related Art

Any discussion of the prior art throughout the specification should in no way be considered as an admission that such prior art is widely known or forms part of a common general knowledge in the field.

Two companies offer ways to measure trading card thickness, namely Ultra Pro International LLC and BCW Diversified Inc. Both companies offer a free downloadable PDF file from their website to an image that offers ways to measure cards as it relates to their specific sizes of trading card holders.

One problem with the conventional trading card measuring concepts is that there is no universal way to measure a card to select a proper trading card holder or for other purposes. Another problem with the conventional trading card measuring concepts is that they do not offer a safe way to preserve the edges, corners, and surface of the card while measuring the thickness of the trading card. A further problem with the conventional trading card measuring concepts is that viewing the measurement on a computer screen could distort the measurement due to differing screen resolutions, zoom settings, and file compression.

The other card thickness measuring devices are not suitable for safely and effectively measuring the thickness of a trading card while preserving the edges, corners, and surface of the card, nor are they suitable for measuring the thickness of any trading card to universally be able to select a proper trading card holder without regard to specific brand.

In these respects, the present invention substantially departs from the conventional concepts and designs of the prior art, and in doing so provides a measurement tool that primarily developed for the purpose of safely and efficiently measuring the thickness of any trading card.

### SUMMARY OF THE INVENTION

In view of the foregoing disadvantages inherent in the known types of card thickness measuring devices now present in prior art, the present invention provides a new trading card thickness measuring tool that has many advantages and many novel features in a new card thickness measuring system which is not anticipated, rendered, obvious, suggested, or even implied by any prior art trading card thickness measurement devices, either alone or in any combination thereof.

To attain this, the present invention is made on transparent plastic to allow for viewing the trading card being measured. Being that it is made on transparent plastic, any side of a trading card can be placed over the top of the invention for measurement; or the invention can be placed over the top of the trading card for measurement. The invention uses a conversion of the common thicknesses of all cards which is measured in points with a conversion that uses an accuracy of 0.001 millimeter, and when printed on the invention itself from a digital file is accurate to 1 pixel, providing a way for trading cards to be measured unlike any other prior art.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In that respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a card thickness measurement system that will overcome the shortcomings of the prior art devices.

A second object is to provide a card thickness measurement system for safely measuring the thickness of trading cards.

Another object is to provide a card thickness measurement system that is inexpensive.

A further object is to provide a card thickness measurement system that can easily be stored and traveled with.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF DRAWINGS

Various other objects, features and intended benefits of the present invention will become fully appreciated as the invention becomes better understood when conserved in conjunction with the accompanying drawings, in which like reference characters designate the same of similar parts throughout several views, and wherein:

FIG. 1 is an upper perspective view of the present invention;

FIG. 2 is a side perspective view of the present invention;

FIG. 3 is an upper perspective view rotated 30 degrees of the present invention in use.

### DETAILED DESCRIPTION OF THE INVENTION

### A. Overview

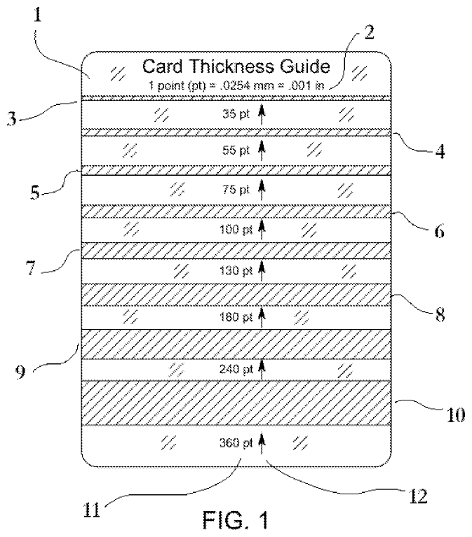

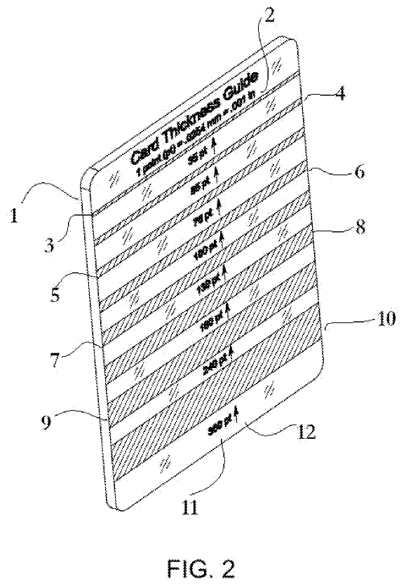

Turning now descriptively to the drawings, in which similar reference characters denote similar elements throughout several views, FIGS. 1 through 3 illustrate a trading card thickness measuring guide 1, which comprises of a 0.03″ thick piece of transparent rigid plastic 11 having several different size gauges that measure 35 point 3, 55 point 4, 75 point 5, 100 point 6, 130 point 7, 180 point 8, 240 point 9, and 360 point 10. The conversion from inches to millimeters to point 2 being displayed at the top for the user to reference. Being made from transparent plastic 11, the invention can be used to measure a card at any angle with the reading arrow 12 and size gauges 3 through 9 being visible on both sides of the present invention.

### B. Plastic

The trading card thickness measuring guide 1 is made of 0.03″ thick transparent plastic 11. Protecting the corners, surface, and edges of a trading card being of utmost importance in preserving value, it is necessary that the invention remains flat over time; a thick rigid plastic of 0.03″ withstands bending and wear over time without changing formation. If wear occurs such as warping of a precision measuring tool, the tool may no longer be accurate. In the present invention, warping or bending would cause the size gauges 3 through 10 to expand or contract affecting the accuracy of the measurement. The thickness of the plastic prevents, or at least delays, any warping or changes to the shape or size of the invention from occurring. The opacity of the plastic 11 allows the present invention to be used at any angle to measure the thickness 13 of a trading card 14, including while the card is encased or inserted inside a trading card holder 15. Being able to measure the card from the top, bottom, or either side of the card, whether or not the card is inserted in a trading card holder, allows the user to measure the card without touching the card itself providing ultimate preservation of quality and therefore value of the card.

### C. Size Gauges

Nearly every trading card ever made ranges in thickness from approximately 0.02″ to 0.35″. The point measurement system 2 (1 point (pt) equals 0.0254 millimeters (mm)=0.001 inches (in)) is the unified system in the manufacturing of the width of the opening of trading card holders which corresponds to the measurement of the thickness of the card that is meant to be inserted. The labeling, packaging, and marketing of trading card holders indicates the point measurement of the holder. All standard trading cards are 35 point 3 in thickness, so this size is generally known as standard size card holders. Cards are manufactured using different card stocks making them different thicknesses like 55 point 4 or 75 point 5, and more often in the modern era cards are created with memorabilia or pieces of a player jersey inserted inside of the card. This makes the card much thicker, usually in the range of 100 point 6 to 180 point 8. Some cards are called “booklet” cards because they fold open and closed like small book and these cards generally range in thickness from 240 point 9 to 360 point 10. The present invention provides a way to measure cards of any common size with size gauges 3 through 10 measured to the pixel with an accuracy of 0.0001 mm and 0.001 in. To obtain this accuracy and convert it to a physical product that is printed in bulk, each individual size gauge 3 through 10 is created using conversion from points to millimeters. This conversion is accurate to 0.0001 mm.

### D. Operation of the Invention

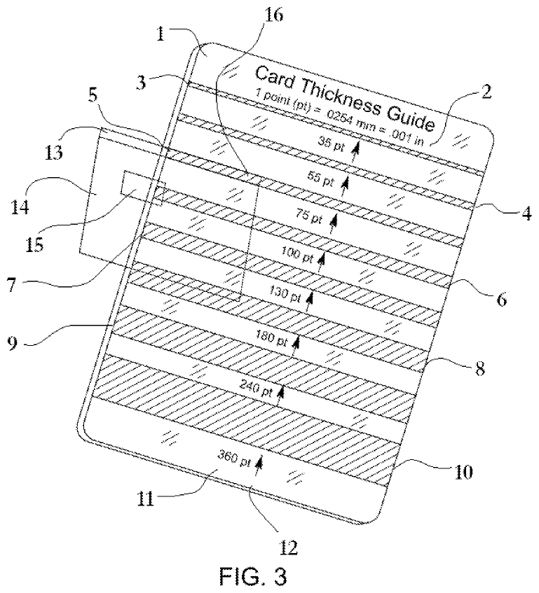

In use, the user places the card thickness guide 1 above a trading card 14 and moves the guide 1 and, while looking through the transparent plastic 11, the user moves the guide 1 up and down to find the size gauge 3 through 10 that matches the thickness of the card 13 as shown in FIG. 3 of the drawings. Alternatively, the user can hold the card thickness guide above a trading card 14 that is placed inside a trading card holder 15, and the user can look through the transparent plastic 11 while moving the guide to find the size gauge 3 through 10 that matches the thickness of the card 13 as shown in FIG. 3 of the drawings. The user can place the card thickness guide 1 over an empty trading card holder 15, while looking through the transparent plastic 11, and the user moves the guide 1 up and down to find the size gauge 3 through 10 that matches the thickness of the trading card holder 15. The user can store the card thickness guide 1 in their pocket, wallet, purse, or any other personal location while the travel away from home allowing them to use the guide 1 conveniently when needed.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. A trading card thickness measuring tool comprising:
a plastic component having a frontward portion and a rearward portion; and
a size gauge;
wherein said size gauge is contained on the frontal portion of said plastic component.

2. A trading card thickness measuring tool as in claim 1, wherein said plastic component is made from a transparent plastic component.

3. A trading card thickness measuring tool as in claim 2, wherein said transparent plastic component is 0.03 inches thick.

4. A trading card thickness measuring tool as in claim 3, wherein said transparent plastic component includes on the frontward portion said size gauge component for measuring trading cards having the thickness of 35 point.

5. A trading card thickness measuring tool as in claim 4, wherein said transparent plastic component includes on the frontward portion said size gauge component for measuring trading cards having the thickness of 55 point.

6. A trading card thickness measuring tool as in claim 5, wherein said transparent plastic component includes on the frontward portion said size gauge component for measuring trading cards having the thickness of 75 point.

7. A trading card thickness measuring tool as in claim 6, wherein said transparent plastic component includes on the frontward portion said size gauge component for measuring trading cards having the thickness of 100 point.

8. A trading card thickness measuring tool as in claim 7, wherein said transparent plastic component includes on the frontward portion said size gauge component for measuring trading cards having the thickness of 130 point.

9. A trading card thickness measuring tool as in claim 8, wherein said transparent plastic component includes on the frontward portion said size gauge component for measuring trading cards having the thickness of 180 point.

10. A trading card thickness measuring tool as in claim 9, wherein said transparent plastic component includes on the frontward portion said size gauge component for measuring trading cards having the thickness of 240 point.

11. A trading card thickness measuring tool as in claim 10, wherein said transparent plastic component includes on the frontward portion said size gauge component for measuring trading cards having the thickness of 360 point.
